(19) United States
(12) Patent Application Publication
(10) Pub. No.: US 2003/0077369 A1
(43) Pub. Date: Apr. 24, 2003

(54) Method for increasing the sweetening power and enhancing the taste of a mixture of extremely powerful sweetening agents

(76) Inventors: Martin Jager, Gauersheim (DE); Margit Doerr, Hohen-Suelzen (DE)

Correspondence Address: FROMMER LAWRENCE & HAUG, 745 FIFTH AVENUE- 10TH FL., NEW YORK, NY, 10151, US

(21) Appl. No.: 10/309,671

(22) Filed: Dec. 4, 2002

Related U.S. Application Data
(63) Continuation of application No. 09/331,270, filed on Jun. 17, 1999, now abandoned.

(30) Foreign Application Priority Data
Dec. 20, 1996 (DE) 196 53 344.9
Jul. 28, 1997 (DE) 197 32 351.0

(51) Int. Cl. A23L 1/236

(52) U.S. Cl. 426/548

(57) ABSTRACT

The invention relates to a method for increasing the sweetening power and enhancing the taste of a mixture of extremely powerful sweetening agents, characterized in that an oligosaccharide is added to the mixture.

The present invention relates to a method of increasing the sweetening power and enhancing the taste of a mixture of high-intensity sweeteners by adding an oligosaccharide.

High-intensity sweeteners are already known and are used to a great extent for sweetening foods. Likewise, mixtures of such substances, for example of acesulfame-K and aspartame, having synergistic increase in sweetening power are already described in the literature (DE-C 26 28 294).

U.S. Pat. No. 5,425,961 describes chewing gum products which include fructooligosaccharides as bulking agents. In addition, the stabilizing action of these fructooligosaccharides on aspartame and, for example, a mixture aspartame/acesulfame/fructooligosaccharides (Example 105) is described. No details are given on the sweetening power of mixtures of this type.

EP-A 646 326 describes a sweetener combination which includes an oligosaccharide in solid or pulverized form which is coated with a sweetener. The object underlying this invention is to provide a solid sweetener mixture containing oligosaccharides in which the oligosaccharide particles do not stick together or aggregate. A further object mentioned is to provide a sweetener mixture with improved flow behavior and sweetening power. However, the synergy implied by the examples and tables is only small.

DE-A 195 14 274 describes an effervescent tablet containing inulin. Inulin in this case is primarily intended to function as fiber, but can also cause a “fuller flavor” in the beverage. Example 2 of this document relates to an effervescent tablet which, in addition to inulin, inter alia also contains acesulfame and aspartame and which gives a soft drink when dissolved in water. The document gives no details of the sweetening power of mixtures of sweeteners and inulin.

Furthermore, there continues to be a great need for sweetener mixtures which have a taste and mouthfeel as similar as possible to a sucrose solution and which achieve this effect with the lowest possible concentrations of sweetener.

Surprisingly, it has now been found that mixtures of at least two high-intensity sweeteners and an oligosaccharide have a sweetening power which greatly exceeds in extent the expectations of those skilled in the art and comes extremely close to the taste and mouthfeel of sucrose.

The present invention therefore relates to a method of increasing the sweetening power and enhancing the taste of a mixture of high-intensity sweeteners, by adding an oligosaccharide to the mixture.

Oligosaccharides within the context of the present invention are, in particular, water-soluble, generally, but not necessarily, non-metabolizable oligosaccharides which comprise at least two monosaccharide components. The number of monosaccharide components which an oligosaccharide according to the claims may comprise is generally subject to no upper limit and is determined, in particular, by the water solubility usually required. Generally, oligosaccharides have 2 to 60 monosaccharide components.

Monosaccharides which the oligosaccharides according to the claims may comprise are generally hexoses, which can be present as furanosides or pyranosides. Examples of monosaccharides are glucose, galactose and fructose. Preferred oligosaccharides are, in particular, inulins, oligofructoses, galactooligosaccharides, isomalto-oligosaccharides, lactosucrose, maltose, glycosylsucrose, maltotetraose and trehalose.

The oligosaccharides according to the claims are known and are commercially available or may be prepared by methods known to those skilled in the art.

Fructooligosaccharides are carbohydrates which belong to the fructan group. In the case of fructooligosaccharides, a distinction is made between inulin and oligofructose. Chemically, inulin is composed of polysaccharides and oligosaccharides which virtually all have the chemical structure GFn (G=glucose, F=fructose and n=the number of fructose units which are linked together as a chain). The degree of polymerization is 2 to 60 molecules. The linkages between the molecules are of a particular type. They have the β(2→1) form, which means that the molecules are indigestible for all higher organisms. Inulin functions as an energy reserve in numerous fruits and plants. In Europe, inulin is prepared industrially from chicory plants. Naturally occurring inulin molecules are extracted from the chicory root, purified and dried. Inulin contains oligofructose which is to an extent an inulin fraction having a low degree of polymerization (about 2 to 9). It is isolated from inulin by hydrolysis. Inulin and oligofructose are recognized as food constituents in Europe.

Galactooligosaccharides are likewise carbohydrates which are chemically a mixture of poly- and oligosaccharides. The degree of polymerization is between 1 and 7 molecules. Galactooligosaccharides are produced industrially from lactose by enzymatic hydrolysis.

Isomaltooligosaccharides are produced from maltose-rich starch hydrolysates by enzymatic hydrolysis. Lactosucrose is produced from lactose, which is present in milk, using the enzyme fructofuranosidase and sucrose is produced from cane sugar. Maltose and trehalose are both disaccharides which consist of two molecules of glucose, but which differ from one another in the type of linkage between the two glucose components. Maltose is equal to sucrose with respect to digestibility, calorific value and cariogenicity. Glycosylsucrose is produced from a mixture of sucrose and starch hydrolysates by the enzyme transferase. It is equal in sweetness profile and calorific value to sucrose, but is markedly less sweet. Maltotetraose is a tetrasaccharide of four molecules of glucose.

The oligosaccharides can be used in the method according to the invention alone or in mixtures with one another.

High-intensity sweeteners which may be used are, in particular, acesulfame-K, cyclamate, saccharin, aspartame, alitame and sucralose. Mixtures according to the claims of these high-intensity sweeteners can consist of two or more individual components, the particular mixing ratios not being critical in principle. In the case of two-component mixtures, suitable mixing ratios are, for example, between 95:5 and 5:95, in particular between 70:30 and 30:70, in the case of an acesulfame-K/aspartame mixture, preferably 50:50. Generally, the best increase in sweetening power in a combination with oligosaccharides is achieved when each sweetener of the sweetener mixture roughly contributes the same sweetness intensity to the sweetener mixture.

Suitable two-component mixtures are, for example, acesulfame-K/cyclamate, acesulfame-K/saccharin, aspartame/cyclamate, aspartame/saccharin, cyclamate/saccharin, acesulfame-K/alitame, aspartame/alitame, aspartame/sucralose, cyclamate/sucralose, cyclamate/alitame, saccharin/sucralose, saccharin/alitame, alitame/sucralose and acesulfame-K/sucralose. Preference is given to a mixture of acesulfame-K and aspartame.

Very good effects are also shown by mixtures of three of the listed sweeteners.

The oligosaccharides can be added to the sweetener mixture in various concentrations which primarily depend on the respective application. A weight ratio of 10:1 to 10,000:1, in particular 500:1 to 5000:1, based on the sweetener mixture, is of practical importance.

In addition to one or more oligosaccharides, taste-modifying substances, such as neohesperidin DC (NHDC), thaumatin or rhamnose, can also be added to the mixtures of high-intensity sweeteners. Here also, the amount added can vary within broad limits and primarily depends on the application.

The oligosaccharides are admixed to the high-intensity sweeteners by methods known per se, for example by mixing the components in suitable mixtures or granulators, or else in fluidized-bed apparatuses. However, joint dissolution in water is also possible.

As the following examples and comparison examples show, the increase in sweetening power which can be achieved by the method according to the invention is surprisingly markedly greater than that which can be achieved using the individual high-intensity sweeteners. Thus, to achieve a defined sweetness, according to the invention smaller amounts of sweetener are sufficient, in comparison with the prior art.

Numerous sensory tests and experimental values have shown that 300 mg/kg of acesulfame-K (ASK) give the same sweetness as a 4.9% strength aqueous sucrose solution. 300 mg/kg of aspartame (APM) give an aqueous solution the same sweetness as 4.6% sucrose. It is already known that a very marked increase in sweetening power occurs if ASK and APM are combined in equal parts (see DE-C 2 628 294). Thus, for example, the combination of 90 mg/kg of ASK with 90 mg/kg of APM is just as sweet as 300 mg/kg of ASK alone or as a 4.9% strength sucrose solution, although it would be assumed that, for example, 150 mg/kg of ASK and 150 mg/kg of APM should be just as sweet as 300 mg/kg of individual sweetener. The increase in sweetening power which is produced by such a combination of ASK and APM in equal parts is thus 40%. When the increase in sweetening power of an ASK/APM combination by oligosaccharides was determined, this previously known increase in sweetening power was taken into account by means of its already being incorporated in the experiments: since, as described above, it is known that 90 mg/kg of ASK and 90 mg/kg of APM have the same sweetness as, a 4.9% strength sucrose solution, the measured sweetening power of the particular oligosaccharide was simply added by calculation. The result of this calculation is the theoretical sweetening power which the particular acesulfame-K/aspartame/oligosaccharide mixture ought to have. In order to establish the actual sweetening power, the particular acesulfame-K/aspartame/oligosaccharide mixtures were tasted against corresponding suitable sucrose solutions and statistically evaluated. It was found in this case, surprisingly, that the actual sweetening powers determined by sensory experiments are considerably higher than the theoretical sweetening powers determined by calculation.

Thus, lactosucrose in a 10% aqueous solution has the same sweetening power as a 3.7% strength aqueous solution of sucrose. If the sweetening power of sucrose is given the value 1, a 10% strength aqueous solution of lactosucrose is 0.37 times as sweet as sucrose. In a 10% strength solution, inulin has the same sweetening power as a 1% strength aqueous solution of sucrose. If, therefore, the sweetening power of sucrose is given the value 1, a 10% strength aqueous solution of inulin is 0.1 times as sweet as sucrose. The mixture of 90 mg/kg of acesulfame-K and 90 mg/kg of aspartame is just as sweet as a 4.9% strength sucrose solution, or the acesulfame-K/aspartame mixture is 0.49 times as sweet as sucrose. If the two sweetening powers are added, that is 0.37 of lactosucrose+0.49 of acesulfame-K/aspartame, this gives a theoretical sweetening power of 0.86 of the sweetening power of sucrose, or a sweetening power corresponding to an 8.6% strength sucrose solution. However, in fact, a sweetening power corresponding to a 10.4% strength sucrose solution was determined, that is 1.04 times as sweet as sucrose. If the sweetening power of 0.86 determined by calculation is taken as 100%, this gives an increase in sweetening power of 20.9% for the actual sweetening power. In the case of inulin, a theoretical sweetening power of 0.1+0.49=0.59 times the sweetening power of sucrose is obtained, or a sweetening power corresponding to a 5.9% strength sucrose solution. However, in fact, a sweetening power corresponding to an 8.2% strength sucrose solution was determined, that is 0.82 times as sweet as sucrose. This gives an increase in sweetening power of 39%, therefore. It must be emphasized here once again that the known increase in sweetening power which is produced solely by the combination of ASK and APM has no influence here on the increase in sweetening power, since the known increase in sweetening power occurring in this case was taken into account by the corresponding reduction in the amounts of the individual sweeteners.

If the combination acesulfame-K/lactosucrose alone, without the additional sweetener aspartame, is considered, the unpredictable increase in sweetness according to the invention becomes very particularly marked.

The sweetness of 300 mg/kg of acesulfame-K corresponds to the sweetness of a 4.9% strength sucrose solution, that is 0.49 times as sweet as sucrose. If acesulfame-K is combined with a 10% strength lactosucrose solution, which is 0.37 times as sweet as sucrose, the sweetness determined by calculation is 0.86 times as sweet as sucrose. However, in fact, a sweetness 0.90 times as sweet as sucrose was determined by sensory tests. Compared with the sweetness intensity of 0.86 determined by calculation, this gives an increase in sweetening power of only 4.7%.

The combination of aspartame and lactosucrose alone also gives the same pattern. 300 mg/kg of APM are 0.46 times as sweet as sucrose. If this is combined with a 10% strength lactosucrose solution, which is 0.37 times as sweet as sucrose, the theoretical sweetening power 0.83 times as sweet as sucrose is given by calculation. In fact, sensory tests determined that the actual sweetening power of this mixture is 0.95 times as sweet as sucrose. This gives an increase in sweetening power of 14.5%.

Both increases in sweetening power of the individual sweeteners with lactosucrose are markedly less than the increase in sweetening power which is achieved by the combination of acesulfame-K and aspartame with lactosucrose.

In the case of inulin, the following pattern results:

acesulfame-K/inulin has a theoretical sweetening power of 0.49+0.1=0.59, but the sweetening power actually determined is 0.64. The increase in sweetening power is thus only 8.5%.

Aspartame/inulin has a theoretical sweetening power of 0.46+0.1=0.56, but the sweetening power actually determined is 0.65. The increase in sweetening power is thus only 16.1%.

Both increases in sweetening power of the individual sweeteners with inulin are markedly lower than the increase in sweetening power which is achieved by the combination of acesulfame-K and aspartame.

In addition to this unexpected synergistic action, the oligosaccharides according to the claims exhibit still other advantageous effects.

Owing to their chemical structure, which cannot be hydrolyzed by the human digestive enzymes, most of the oligosaccharides are not digested in the small intestine, but act as soluble fibers. Not until the large intestine are they fermented without residue by the beneficial microflora. This is principally carried out by the endogenous bifidobacteria. This process stimulates the growth of the endogenous bifidobacteria and inhibits the growth of harmful bacteria, such as enterobacteriaceae or streptococci. A change of this type in the composition of the intestinal flora is considered to be beneficial to humans. Oligosaccharides having these properties are therefore termed “prebiotic”, since they stimulate the development of the endogenous desirable bacteria in the digestive tract. In addition, this activates the immune system and the synthesis of vitamins (eg B₁ and B₁₂) and improves the uptake of some minerals. The uptake of oligosaccharides of this type in a sufficient amount thus generally makes a positive contribution to the well-being and health of humans.

The consequence of this special metabolism is that these oligosaccharides supply only a very few calories to the body. In the large intestine, the microorganisms can convert the product into free fatty acids, some of which are absorbed. Owing to this metabolic process, the calorific value of inulin at only 1 kcal/g and of oligofructose at only 1.5 kcal/g is markedly below that of fat, fructose, glucose, sugars and starch.

The uptake of oligosaccharides of this type also causes typical fiber effects, since they increase the transit rate of the intestinal contents and they increase the stool weight, decrease the pH in the intestine, improve the ratio of HDL/LDL cholesterol, decrease the triglycerol and fat values in the blood and prevent constipation.

Oligosaccharides having the above-described properties have no effect on blood glucose level, do not stimulate insulin secretion and do not affect the glucagon level. Therefore, they are suitable for diabetics.

Since no fructose or glucose is released by the oral flora during the metabolism of, for example, inulin, isomaltooligosaccharides or lactosucrose, these substances cause virtually no caries and no dental plaque.

Since fructo- and galactooligosaccharides, just as isomaltooligosaccharides and lactosucrose, give the product body in the amount added, since they are soluble fiber, the viscosity of the product is increased and thus the mouthfeel is markedly and very pleasantly improved, actually without intrusive fibers in the product as are known from traditionally fiber-enriched beverages (“bran effect”).

Glycosylsucrose, owing to its special mode of preparation, has the advantage of not being cariogenic, since the sucrose present therein cannot be fermented by the bacteria in the oral cavity. It thus has the same beneficial properties giving body in beverages as conventional saccharides, but without the hazard of causing caries.

A further advantage of oligosaccharides according to the claims such as maltotetraose, maltose or trehalose is the improved technological properties, particularly with respect to foods other than beverages. In this case it has been found that bakery products and confectionary, for example, which are greatly improved with respect to the technological properties can be produced. However, since these oligosaccharides are markedly less sweet than commercially conventional sugars, increasing the sweetness using sweeteners is necessary. The sweeteners here also act as taste intensifiers/enhancers, ie the sweet taste of the mixture of sweeteners and these oligosaccharides becomes much more sugar-like than would be expected.

Maltose, used instead of some of the sugar, for example, in bakery products prevents starch retrogradation, which leads to staling of bakery products, very much better than conventional saccharides, but otherwise has the properties of conventional saccharides (eg sucrose, fructose, glucose), such as the low water activity.

Trehalose likewise prevents retrogradation of the starch in bakery products. In addition, if trehalose is employed as sugar substitute mixed with sweeteners, the bakery products are pleasant, aromatic and juicy. Jelly babies which were made with a portion of trehalose have a very fruity and aromatic taste. If hard candies are made from trehalose, these are very stable with respect to atmospheric humidity and do not, have a tendency toward recrystallization, as do conventional hard candies produced from sucrose and glucose sirup.

Maltotetraose likewise has the outstanding property of a humectant, for example in gum confectionary products which remain soft and fresh for a very long time, but outstandingly prevents the recrystallization of the sucrose/glucose sirup.

Glycosylsucrose also gives gum confectionary products, for example, a very good consistency, and likewise prevents the recrystallization of sucrose, for example, keeps gum confectionary products pleasantly soft and, in combination with sweeteners, has a very good sweetness profile. These advantages, particularly with regard to the taste, are increased because of the fact that glycosylsucrose is not cariogenic, but otherwise acts as sucrose. The calorific value is roughly the same, but in contrast to “sugar-free” gum confectionary products sweetened with sugar alcohols, the products produced from glycosylsucrose are not laxative.

On the international market for beverages and milk products, there are numerous products in which one or more sweeteners are combined with other, sometimes sweet-tasting, substances giving body. Substances of this type are, for example, sucrose, fructose, high fructose corn sirup, glucose sirup etc. A greater or lesser increase in sweetening power also occurs with these combinations of sweeteners with sugars. The increase in sweetening power, and possibly the more pleasant mouthfeel which is attained by the use of sugars giving body and the thereby increased viscosity, are the decisive factors for the combination of sweeteners and sugars. However, use of these sugars achieves no further advantage apart from said effects such as increase in sweetening power and improving the mouthfeel. Said substances are cariogenic, and therefore initiate caries if teeth are not cleaned immediately after consumption. Since these substances consist of carbohydrates which are immediately utilized and absorbed by the human body at approximately 4 kcal/g, the calorific value/energy content of the product in which this combination is used is considerably increased.

Sugars, except for fructose, are not suitable for consumption by diabetics, since they stimulate insulin secretion and increase the blood sugar level. Thus products in which sugars of this type are added in the amount required for increase in sweetening power are also no longer suitable for diabetics.

Combination of sweeteners with sugars, apart from the increase in sweetening power and improving the mouthfeel, does not create any health advantages, as is the case with combination of sweeteners with oligosaccharides. The advantages of combination of sweeteners with oligosaccharides, to summarize once more individually; are: fiber-enrichment, pro-bifidus effect (prophylaxis of colon carcinoma), suitability for diabetics, low calorie content, pleasant mouthfeel, non-cariogenicity.

Practical experiments have also shown that the use of the oligosaccharides according to the claims together with a mixture of high-intensity sweeteners does not give any significant sensory differences from corresponding products sweetened with sugar even if products such as cultured milk beverages or fruit juice beverages, for example, which are highly sensitive with respect to sensory testing. This is particularly advantageous, since sugar is regarded as the standard of the sweet taste. It is therefore possible to produce products which are equivalent to the conventional products sweetened with sugar.

The method according to the invention of increasing the sweetening power and enhancing the taste can thus be employed in the production of foods of the most varied types. Examples are bakery products, such as cakes, confectionary products, such as jelly babies, hard candies and chocolate, but especially also beverages, such as lemonades, fruit juice beverages, fizzy drinks and fruit juices and liquid and semiliquid milk products, such as yogurt, drinking yogurt, cultured milk or buttermilk, and bread spreads and all types of icecream. In addition, the method according to the invention may also be used in the production of pet-food and farm animal feed and of medicament formulations, however.

Said foods, in addition to the mixtures of high-intensity sweeteners and oligosaccharides, include the base materials and auxiliaries which are known per se, such as flavorings and aroma substances, moisture regulators, preservatives, etc. in the amounts and concentrations which are known per se and customary.

### EXAMPLES

Sweetening power of oligosaccharides and sweeteners used:

| | | Sweetening power |
|---|---|---|
| | Concentration in | in aqueous solution |
| | aqueous solution | (sucrose = 1) |
| Inulin (powder) | 10% | 0.10 |
| Oligofructose (sirup) | 10% | 0.45 |
| Galactooligosaccharide (sirup) | 10% | 0.32 |
| Lactosucrose (powder) | 10% | 0.37 |
| Isomaltooligosaccharide | 10% | 0.26 |
| (sirup) | | |
| Glycosylsucrose (sirup) | 10% | 0.29 |
| Maltotetraose (sirup) | 10% | 0.17 |
| Maltose (powder) | 10% | 0.36 |
| Trehalose (powder) | 10% | 0.32 |
| Acesulfame-K (powder) | 0.03% | 0.49 |
| Aspartame (powder) | 0.03% | 0.46 |
| Acesulfame-K + aspartame | 0.009% | 0.49 |
| | each | |
| Cyclamate (powder) | 0.133% | 0.40 |
| Acesulfame-K | 0.0225% | 0.40 |
| Cyclamate + acesulfame-K | 0.0417 + 0.0083% | 0.39 |
| Alitame (powder) | 0.002% | 0.49 |
| Acesulfame-K | 0.03% | 0.49 |
| Alitame + acesulfame-K | 0.001% + 0.009% | 0.49 |
| Alitame | 0.002% | 0.49 |
| Aspartame | 0.03% | 0.46 |
| Alitame + aspartame | 0.001% + 0.009% | 0.41 |
| Cyclamate | 0.145% | 0.43 |
| Saccharin (powder) | 0.0085% | 0.42 |
| Cyclamate + saccharin | 0.05% + 0.005% | 0.43 |
| NHDC (powder) | 0.016% | 0.64 |
| Acesulfame-K¹⁾ | 0.075% | 0.65 |
| Aspartame | 0.05% | 0.66 |
| NHDC + acesulfame-K + | 0.001% + | 0.65 |
| aspartame | 0.009% + 0.009% | |
| Alitame | 0.0017% | 0.42 |
| Saccharin | 0.0085% | 0.42 |
| Alitame + saccharin | 0.001% + 0.005% | 0.42 |
| NHDC = Neohesperidine DC | | |
| ¹⁾It is known that the sweetening power of sweeteners decreases with increasing sweetness intensity. For each sweetener, this sweetness intensity curve, or also termed sweetening power curve, is individual and different. Therefore, it is known that to achieve a sweetness intensity of 0.65 in comparison with sucrose, 750 mg/kg or 0.075% of acesulfame-K are needed, for example, but only 500 mg/kg or 0.05% of aspartame are required to achieve a similar sweetness intensity of | | |
| # 0.66 in comparison with sucrose. | | |

### Example 1

A mixture of 99.82% by weight of lactosucrose in powder form and 0.09% by weight each of acesulfame-K and aspartame was produced and a 10.018% strength by weight aqueous solution was prepared therefrom. The sweetness of this solution was determined in sensory tests.

The theoretical sweetening power in comparison with sucrose (sucrose =1) in accordance with the above table is 0.86. The sweetening power actually determined is 1.04, however. The increase in sweetening power is therefore 20.9%.

As a comparison, the above experiment was repeated, but 0.3% by weight of acesulfame-K was used instead of the mixture of aspartame and acesulfame-K. The theoretical sweetening power of this mixture is 0.86, but that actually determined is 0.90. The increase in sweetening power is therefore only 4.7%.

A second repetition of the experiment using 0.3% by weight of aspartame instead of the aspartame/acesulfame-K mixture gave an actual sweetness of 0.95 instead of a theoretical sweetness of 0.83. The increase in sweetening power is therefore only 14.5%.

A repetition of Example 1 using further oligosaccharides, but likewise using acesulfame-K and aspartame and in the same weight ratios gave the results below:

| | | Theoretical | Actual | Increase in |
|---|---|---|---|---|
| | Oligo- | sweetening | sweetening | sweetening |
| | saccharide | power | power | power |
| Example 2 | Glycosyl- | 0.78 | 0.93 | 19.2% |
| Comparison: | sucrose | | | |
| only ASK | (sirup) | 0.78 | 0.83 | 6.4% |
| only APM | | 0.75 | 0.86 | 14.7% |
| Example 3 | Maltose | 0.85 | 1.14 | 34.1% |
| Comparison: | (powder) | | | |
| only ASK | | 0.85 | 0.98 | 15.3% |
| only APM | | 0.82 | 1.0 | 22.0% |
| Example 4 | Trehalose | 0.81 | 1.1 | 35.8% |
| Comparison: | (powder) | | | |
| only ASK | | 0.81 | 0.96 | 18.5% |
| only APM | | 0.78 | 0.94 | 20.5% |
| Example 5 | Inulin | 0.59 | 0.82 | 39.0% |
| Comparison: | (powder) | | | |
| only ASK | | 0.59 | 0.64 | 8.5% |
| only APM | | 0.56 | 0.65 | 16.1% |
| Example 6 | Oligofructose | 0.94 | 1.28 | 36.2% |
| Comparison: | (sirup) | | | |
| only ASK | | 0.94 | 0.96 | 2.1% |
| only APM | | 0.91 | 0.71 | −22.0% |
| Example 7 | Galactooligo- | 0.81 | 0.95 | 17.3% |
| Comparison: | saccharide | | | |
| only ASK | (sirup) | 0.81 | 0.72 | −11.1% |
| only APM | | 0.78 | 0.82 | 5.1% |

Notes on the Comparison Examples 6 and 7:

The measured increase in sweetening power is negative here in the case of APM or ASK. This means that the sweetening power of the individual sweetener/oligosaccharide mixture measured by sensory tests is less than the theoretical sweetening power which was determined by calculation. It is known that sweet-tasting substances can inhibit each other, so that the sweetening power produced by the mixture is less than one would assume (“=reduction in sweetening power”). It is therefore of all the more interest that with the sweetener mixture/oligosaccharide combination, the increase in sweetening power is very marked.

A repetition of Example 1 with other sweetener/oligosaccharide mixtures gave the results below:

| | | Theoretical | Actual | Increase in |
|---|---|---|---|---|
| Sweetener | Oligo- | sweetening | sweetening | sweetening |
| mixture | saccharide | power | power | power |
| Example 8 | | | | |
| 83 mg/kg ASK | Malto- | 0.56 | 0.70 | 25.0% |
| 417 mg/kg CYC | tetraose | | | |
| comparison: | (Sirup) | | | |
| only ASK | | 0.57 | 0.63 | 10.5% |
| (225 mg/kg) | | | | |
| only CYC | | 0.57 | 0.66 | 15.8% |
| (1330 mg/kg) | | | | |
| Example 9 | | | | |
| 90 mg/kg ASK | Maltose | 0.85 | 1.08 | 27.1% |
| 10 mg/kg alitame | | | | |
| comparison: | | | | |
| only ASK | | 0.85 | 0.98 | 15.3% |
| (300 mg/kg) | | | | |
| only alitame | | 0.85 | 0.98 | 15.3% |
| (20 mg/kg) | | | | |
| Example 10 | | | | |
| 500 mg/kg CYC | Lacto- | 0.80 | 1.04 | 30.0% |
| 50 mg/kg SAC | sucrose | | | |
| comparison: | (powder) | | | |
| only CYC | | 0.80 | 1.01 | 26.3% |
| (1450 mg/kg) | | | | |
| only SAC | | 0.79 | 0.78 | −1.3% |
| (85 mg/kg) | | | | |
| Example 11 | | | | |
| 10 mg/kg alitame | Inulin | 0.59 | 0.75 | 27.1% |
| 90 mg/kg ASK | (powder) | | | |
| comparison: | | | | |
| only alitame | | 0.59 | 0.67 | 13.6% |
| (20 mg/kg) | | | | |
| only ASK | | 0.59 | 0.64 | 8.5% |
| (30 mg/kg) | | | | |
| Example 12 | | | | |
| 10 mg/kg alitame | Inulin | 0.51 | 0.63 | 23.5% |
| 90 mg/kg APM | (powder) | | | |
| comparison: | | | | |
| only alitame | | 0.59 | 0.67 | 13.6% |
| (20 mg/kg) | | | | |
| only APM | | 0.56 | 0.65 | 16.1% |
| (300 mg/kg) | | | | |
| Example 13 | | | | |
| 10 mg/kg NHDC | Inulin | 0.75 | 1.01 | 34.7% |
| 90 mg/kg ASK | (powder) | | | |
| 90 mg/kg APM | | | | |
| comparison: | | | | |
| only NHDC | | 0.74 | 0.74 | 0.0% |
| (160 mg/kg) | | | | |
| only ASK | | 0.75 | 0.77 | 2.7% |
| (750 mg/kg) | | | | |
| only APM | | 0.76 | 0.91 | 19.7% |
| (500 mg/kg) | | | | |
| Example 14 | | | | |
| 10 mg/kg alitame | Oligo- | 0.87 | 1.05 | 20.7% |
| 50 mg/kg SAC | fructrose | | | |
| comparison: | (sirup) | | | |
| only alitame | | 0.87 | 0.90 | 3.5% |
| (17 mg/kg) | | | | |
| only SAC | | 0.87 | 0.88 | 1.2% |
| (85 mg/kg) | | | | |
| Example 15 | | | | |
| 10 mg/kg NHDC | Oligo- | 1.10 | 1.32 | 20.0% |
| 90 mg/kg ASK | fructose | | | |
| 90 mg/kg APM | (sirup) | | | |
| comparison: | | | | |
| only NHDC | | 1.09 | 0.99 | −10% |
| (160 mg/kg) | | | | |
| only ASK | | 1.10 | 1.13 | 2.7% |
| (750 mg/kg) | | | | |
| only APM | | 1.11 | 1.16 | 4.5% |
| (500 mg/kg) | | | | |

Abbreviations:
ASK Acesulfame-K
CYC Cyclamate
SAC Saccharin
NHDC Neohesperidin DC

Notes on the Comparison Examples 10 and 15:

The measured increase in sweetening power is negative here in the case of SAC or NHDC. This means that the sweetening power of the individual sweetener/oligosaccharide mixture measured by sensory tests is less than the theoretical sweetening power which was determined by calculation. It is known that sweet-tasting substances can inhibit each other, so that the sweetening power produced by the mixture is less than one would assume (“=reduction in sweetening power”). It is therefore of all the more interest that with the sweetener mixture/oligosaccharide combination, the increase in sweetening power is very marked.

### Application Example 1

An orange fruit drink of the following composition was produced:

10% by weight of orange juice concentrate,

4.5% by weight of lactosucrose

0.0060% by weight of acesulfame-K

0.0060% by weight of aspartame

made up to 100% by weight with water.

As comparison example (standard) an orange fruit drink of the following composition was used:

10% by weight of orange juice concentrate

6% by weight of sucrose

made up to 100% by weight with water.

A sensory test with respect to deviation from the standard was carried out using the questions

Which sample is sweeter?

Which sample tastes better?

Which sample is more sugar-like?

No statistically significant difference was observed.

### Application Example 2

A drinking yogurt of the following composition was produced:

30% by weight of whey

10% by weight of multivitamin juice

5% by weight of trehalose

0.0065% by weight of acesulfame-K

0.0065% by weight of aspartame

made up to 100% by weight with natural yogurt (fat content: 1.5%).

As comparison example (standard), a drinking yogurt of the following composition was used:

30% by weight of whey

10% by weight of multivitamin juice

6.5% by weight of sucrose

made up to 100% by weight with natural yogurt (fat content: 1.5%).

A sensory test as reported in Application Example 1 showed no statistically significant differences.

### Application Example 3

A drinking yogurt of the following composition was produced:

30% by weight of whey

10% by weight of multivitamin juice

5% by weight of maltose

0.0045% by weight of acesulfame-K

0.0005% by weight of alitame

made up to 100% by weight with natural yogurt (fat content: 1.5%).

As comparison example (standard) a drinking yogurt of the following composition was used:

30% by weight of whey

10% by weight of multivitamin juice

5.5% by weight of sucrose

made up to 100% by weight with natural yogurt (fat content: 1.5%).

A sensory test as reported in Application Example 1 showed no statistically significant differences.

### Application Example 4

A drinking yogurt of the following composition was produced:

30% by weight of whey

10% by weight of multivitamin juice

5% by weight of trehalose

0.0050% by weight of acesulfame-K

0.0050% by weight of aspartame

made up to 100% by weight with natural yogurt (fat content: 1.5%).

As comparison example (standard) a drinking yogurt of the following composition was used:

30% by weight of whey

10% by weight of multivitamin juice

6.0% by weight of sucrose

made up to 100% by weight with natural yogurt (fat content: 1.5%).

A sensory test as reported in Application Example 1 showed no statistically significant differences.

### Application Example 5

A drinking yogurt of the following composition was produced:

30% by weight of whey

10% by weight of multivitamin juice

4.5% by weight of lactosucrose

0.0035% by weight of saccharin

0.00350% by weight of cyclamate

made up to 100% by weight with natural yogurt (fat content: 1.5%).

As comparison example (standard) a drinking yogurt of the following composition was used:

30% by weight of whey

10% by weight of multivitamin juice

6.0% by weight of sucrose

made up to 100% by weight with natural yogurt (fat content: 1.5%).

A sensory test as reported in Application Example 1 showed no statistically significant differences.

### Application Example 6

An orange fruit drink of the following composition was produced:

10% by weight of orange juice concentrate

5.0% by weight of glycosylsucrose sirup

0.0065% by weight of acesulfame-K

0.0065% by weight of aspartame

made up to 100% with water.

As comparison example (standard) an orange fruit drink of the following composition was used:

10% by weight of orange juice concentrate

6% by weight of sucrose

made up to 100% by weight with water.

A sensory test as reported in Application Example 1 showed no statistically significant differences.

### Application Example 7

An orange fruit drink of the following composition was produced:

10% by weight of orange juice concentrate

4.5% by weight of maltose

0.0050% by weight of acesulfame-K

0.0050% by weight of aspartame

made up to 100% by weight with water.

As comparison example (standard), an orange fruit drink of the following composition was used:

10% by weight of orange juice concentrate

6% by weight of sucrose

made up to 100% by weight with water.

A sensory test as reported in Application Example 1 showed no statistically significant differences.

### Application Example 8

An orange fruit drink of the following composition was produced:

10% by weight of orange juice concentrate

5.0% by weight of oligofructose sirup

0.0005% by weight of neohesperidin DC

0.0045% of acesulfame-K

0.0045% by weight of aspartame

made up to 100% by weight with water.

As comparison example (standard), an orange fruit drink of the following composition was used:

10% by weight of orange juice concentrate

6.5% by weight of sucrose

made up to 100% by weight with water.

A sensory test as reported in Application Example 1 showed no statistically significant differences.

1. A method of increasing the sweetening power and enhancing the taste of a mixture of high-intensity sweeteners, which comprises adding an oligosaccharide to the mixture.

2. The method as claimed in claim 1, wherein the oligosaccharides used are inulins, oligofructoses, galactooligosaccharides, isomaltooligosaccharides, lactosucrose, maltose, glycosylsucrose, maltotetraose or trehalose.

3. The method as claimed in claim 1 and/or 2, wherein, as high-intensity sweeteners, use is made of acesulfame-K, cyclamate, saccharin, aspartame, alitame and sucralose.

4. The method as claimed in one or more of claims 1 to 3, wherein, as mixture of high-intensity sweeteners, use is made of acesulfame-K/cyclamate, acesulfame K/saccharin, aspartame/cyclamate, aspartame/saccharin, cyclamate/saccharin, acesulfame-K/alitame, aspartame/alitame, aspartame/sucralose, cyclamate/sucralose, cyclamate/alitame, saccharin/sucralose, saccharin/alitame, alitame/sucralose or acesulfame-K/sucralose.

5. The method as claimed in claim 4, wherein the sweeteners are present in a mixing ratio between 95:5 and 5:95, in particular between 70:30 and 30:70.

6. The method as claimed in one or more of claims 1 to 5, wherein the mixture of high-intensity sweeteners used is acesulfame-K/aspartame.

7. The method as claimed in claim 6, wherein acesulfame-K and aspartame are present in a mixing ratio of 50:50.

8. The method as claimed in one or more of claims 1 to 7, wherein the oligosaccharide and the mixture of high-intensity sweeteners are used in a ratio of 10:1 to 10,000:1, in particular 500:1 to 5000:1.

9. The method as claimed in one or more of claims 1 to 8, wherein other taste-modifying substances are added to the mixture.

10. The method as claimed in claim 9, wherein, as taste-modifying substances, use is made of neohesperidin D, thaumatin or rhamnose.
